(19) United States
(12) Patent Application Publication
(10) Pub. No.: US 2009/0136896 A1
(43) Pub. Date: May 28, 2009

(54) DENTAL APPARATUS FOR SHAPING AND CLEANING A ROOT CANAL

(75) Inventor: David Meyer Shuster, Suffolk (GB)

Correspondence Address: EGBERT LAW OFFICES, 412 MAIN STREET, 7TH FLOOR, HOUSTON, TX, 77002, US

(73) Assignee: MICRO MEGA INTERNATIONAL MANUFACTURES (Societe Anonyme), Besancon (FR)

(21) Appl. No.: 12/160,274

(22) PCT Filed: Jan. 10, 2007
(86) PCT No.: PCT/IB07/00546

§ 371 Date: Jul. 8, 2008

(30) Foreign Application Priority Data
Jan. 24, 2006 (GB) 0601361.9

(51) Int. Cl. A61C 5/02

(52) U.S. Cl. 433/102; 433/224

(57) ABSTRACT

Apparatus is disclosed for use in cleaning dental root canals using an endodontic file. The file is mounted in a drill head driven by an electric motor. The motor is normally driven in one, forward direction, but periodically, the motor rotation is reversed for a very short time. The duration of the motor reversal is so short that although the motor rotates in the reverse direction, the inertia and backlash in the transmission between the motor output shaft and the drill head is such that the direction of rotation of the file in the root canal is not changed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to dental root canal work, and in particular to an apparatus for shaping and cleaning a root canal in preparation for filling that canal.

2. Description of Related Art Including Information Disclosed Under 37 CFR 1.97 and 37 CFR 1.98.

Endodontics is the name given to root canal treatment. Endodontic treatment conventionally involves removal of the irreversibly damaged nerve tissue or pulp and some dentine, followed by cleaning and disinfection of the root canal space and subsequent obturation or filling of the canal to form a seal capable of preventing future bacterial penetration.

Shaping and cleaning of the root canal is done using an endodontic file, which may be mounted in a motorized drill or may be manipulated by hand. The file will be moved in and out of the canal and, when being manipulated by hand, can be rotated in both directions like winding a watch as well as being rotated continually in one direction.

An endodontic file is a very fine probe with a working portion, which has helical flutes tapering to a point and is capable of at least some flexibility to be able to direct itself along a root canal which is not entirely straight. Endodontic files are design to be either motor driven or hand driven. Motor driven files (with which this specification is concerned) have a mandrel portion which is fitted in a drill head and which engages with the drill head so that the file can be driven in rotation. In this specification, the process of rotating an endodontic file in a root canal will be referred to as shaping and filing.

Endodontic files do however become choked with debris, which cannot always be carried away from the cutting edge of the file along the helical flute of the file, and the present invention seeks to address this problem. This causes a reduction of cutting efficiency and in severe cases, can lead to the file breaking off in the tooth.

### BRIEF SUMMARY OF THE INVENTION

According to the invention, there is provided apparatus for shaping and cleaning a root canal, the apparatus comprising a drill driven by an electric motor through a transmission system, means for mounting an endodontic file in a drill head, means for causing the motor to rotate at a normal speed in a normal rotational direction and for intermittently causing the motor to rotate at a speed and/or direction substantially different from the normal speed or direction for a very short time.

Preferably the speed, substantially different from the normal speed, is a speed in the opposite direction of rotation; i.e. the motor is intermittently caused to rotate in a reverse direction compared to the normal speed direction.

In a conventional dental drill with an electric motor for rotating the drill chuck, there is a certain degree of play in the drive train between the motor itself and the drill head, i.e., in the dental handpiece gears. This play may be the result of backlash in a gear train, or any other type of play, or energy absorbtion between the motor and the endodontic file. There will also be inertia to be considered in the drive train and the motor.

An endodontic file has flutes, at least some of which, when the file is being driven, are in frictional contact with the root canal walls. The portion of the file between the part, which is in contact with the root canal walls and the part mounted in the drill head will be loaded by twisting and will thus be storing energy in the form of torsion energy. When this twisting takes place, the file will “wind up” and the winding up of the file will result in a radial expansion of the part of the file between the part in frictional contact with the root canal walls and the part mounted in the drill head.

Reversing the direction of the motor and then restoring the original direction of rotation produces a pulse in the transmission between the motor and the drill head. The pulse results in a disruption of the connection between the motor and the flutes of the drill as a result of which the energy stored in the file through the previous twisting of the flutes is released to drive the flutes. When the torsion energy is released, the flutes may unwind and reduce in diameter. Depending on the position along its length at which the file is in frictional contact with the root canal walls, the part of the file, which unwinds may momentarily turn in either direction.

Preferably the direction of the current driving the motor is reversed in order to interrupt the normal speed of the motor. Reversing the direction of the current for a short time may or may not cause the motor to actually rotate in a reverse direction but will cause an interruption in the normal speed of the motor.

A pulse in the transmission may also be achieved by intermittently decelerating or accelerating the motor at a frequency, which will ensure a change in the rotational speed but no change in the direction of rotation of the motor. This can include decelerating the motor to a stop and the accelerating the motor back to its normal operating speed. The intermittent changes in motor rotation preferably take place regularly, although a random program of changes would also be effective. The normal speed can typically be in the range 300 rpm to 650 rpm. The very short time, during which the normal speed is interrupted, can be, for example, in the range of 1 to 4 milliseconds, and this interruption can take place for example at a frequency of up to 100 Hz. The frequency is however very dependant upon the speed of rotation. The requirement is to maintain the gears in mesh in the drive train, and this will require the same numbers of degrees of rotation whatever the speed. Thus, the speed will influence the rate at which the “unwinding” is achieved. At higher forward rotation speeds, the period of the reverse pulse will either need to be shorter than at low speeds or the reverse pulse may be of a magnitude intended to drive the motor in reverse at a speed different from, and lower than the speed in the forward direction. In the latter case, the very short time for which the normal speed is interrupted may be up to 10 milliseconds.

In particular for faster rotating files (up to 2000 rpm), it may only be necessary to generate a substantial reduction in speed of rotation to achieve the effect of the invention, although it may require a reverse current to achieve sufficient deceleration.

The motor is preferably a stepper motor which can be easily caused to change speed and/or direction, but the invention can also be used with a continuously rotating motor, particularly if the frequency and extent of the intermittent interruptions in the normal motor rotation can be established and programmed into the motor drive circuit.

The invention also extends to a method of shaping and cleaning a root canal using a dental drill driven by an electric motor, wherein an endodontic file is mounted in the drill head, the motor is operated at a normal speed in a normal rotational direction in which flutes of the file are in a cutting mode and while the file is within the root canal the motor is driven intermittently at a speed and/or direction substantially different from the normal speed or direction for a very short time.

Preferably, the speed substantially different from the normal speed is a speed in the opposite direction of rotation; i.e., the motor is intermittently rotated in a reverse direction compared to the normal speed direction.

The invention is not restricted to root canal dental work (it is possible that it could be used in post space preparation) or even to dental work in general. The method of the invention may be applied to any operation where it is desired to impart a pulse or vibration to a rotating bit (e.g. a drill or a file) while the bit is working, without stopping the bit from rotating and cutting.

It is widely accepted that a significant proportion of the loading on a rotary endodontic file is associated with the dentine debris created by the cutting process, both the friction component and also the management/discharging component.

To assess cutting efficiency the number of clockwise (cutting) revolutions completed to reach a required depth of cut in a sample of test material can be measured, and this technique can be used to assess the optimum parameters for rotation of the motor. The number of clockwise (cutting) revolutions completed can be used as a means of assessing the efficiency of discharge of debris.

### BRIEF DESCRIPTION OF THE SEVERAL VIEWS OF THE DRAWINGS

The invention will now be further described, by way of example, with reference to the accompanying drawings.

FIG. 1 shows a perspective view of an endodontic file on an enlarged scale and in a relaxed state.

FIG. 2 shows a perspective view of the file of FIG. 1 after engagement in a root canal, with the file “wound up”.

FIG. 3 is a schematic view of a dental handpiece with an electric motor and a drive train between the motor and the drill head.

FIG. 4 shows a sectional view of a dental handpiece connected to an electric motor.

FIG. 5 is a schematic illustration of a control circuit for use in carrying out the invention.

### DETAILED DESCRIPTION OF THE INVENTION

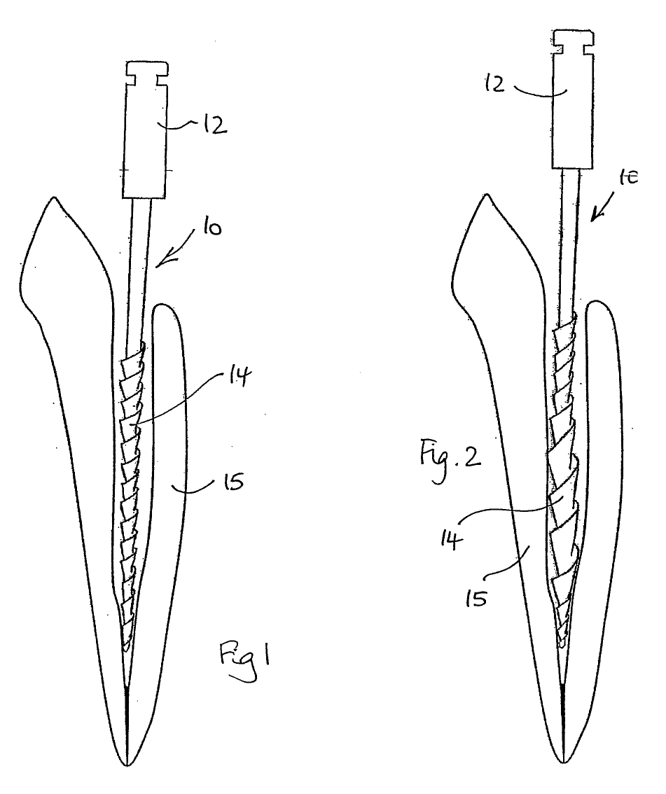

The endodontic file 10 shown in FIG. 1 has a mandrel 12 which is shaped to fit into the drill head of a drill handpiece, and a tapered, helically fluted working portion 14.

The file is designed to be rotated in one direction, and the flutes have a leading edge which cuts or scrapes the dentine from the walls of the tooth's root canal. As the files rotate, they cut dentine from the walls of the tooth and also collect the remaining soft pulp tissue.

The file is made of a flexible metal alloy, so that it can bend, whilst still being rotated, to follow the curves of a root canal, which may follow a meandering path. The flexibility of the alloy also means that the file will “wind up”; i.e., the file will be twisted, when torque is applied to the head of the file and when part of the file is in frictional contact with the root canal walls. This winding up of the file will result in a radial expansion of the part of the file between the part in frictional contact with the root canal walls and the mandrel 12.

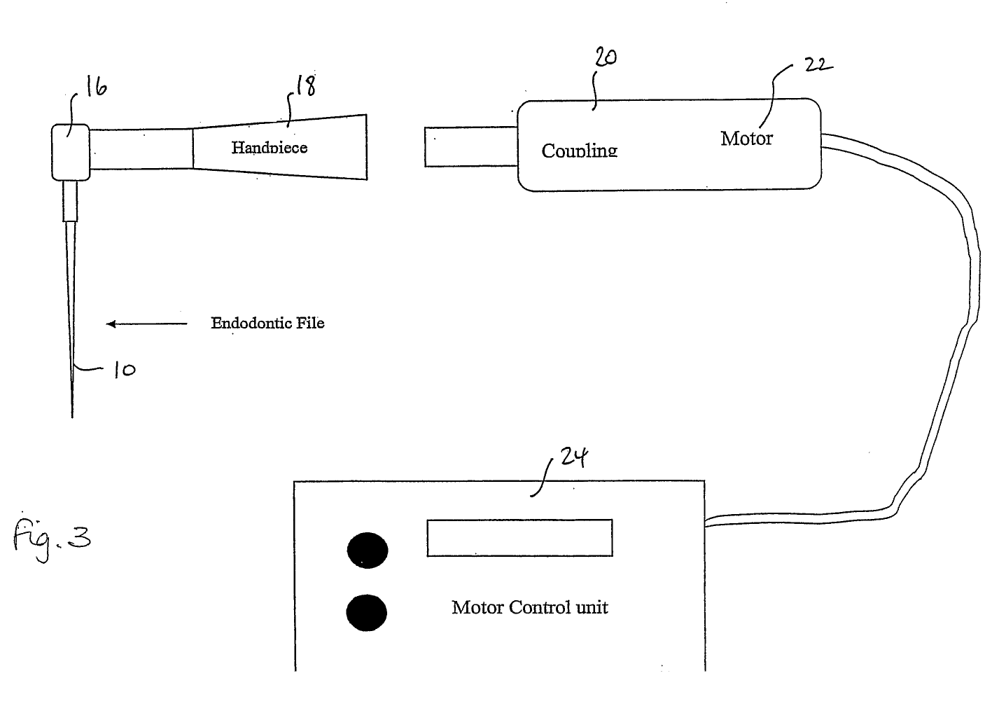

When the file winds up the blades unwind. The file increases in diameter and increases it's length. This can be seen in FIG. 2 where the file is shown within the root canal of a tooth 15. The increase in diameter causes the blades to maintain their engagement with the dentine wall and produces a filing action in the long axis of the canal (in addition to the filing action caused by the axial vector of the rotations). As the file winds up the flute spacing also increases.

When the file relaxes, the blades wind up and move away from the canal wall and, in addition, the blades move axially. Also, the flute spacing becomes smaller, displacing the dentine chip because the blades have moved away from the canal wall and the chips are not carried apically (i.e. not towards the bottom of the canal). This is “pumping” of the dentine chips. It creates another mechanism for debris removal.

The filing mechanism of an endodontic file is related to rake angle (the angle which the flute leading edge makes to the canal wall) and other parameters such as the speed of rotation, the driving torque and the advancement force. A positive rake angle pumps out better and restores cutting relaxed position of flutes without moving material apically, acting as a non-return valve. Files with the trade names HERO SHAPER™, GT™ and PRO-TAPER™ may be particularly suitable. The mechanism will also be proportional to the diameter of the file; larger diameter files are less likely to see such big improvements as fine files.

The invention applies to files, which are designed to continuously rotate. Although the files shown in the figures are of a tapered form, the techniques described here can also be applied to files of alternative forms.

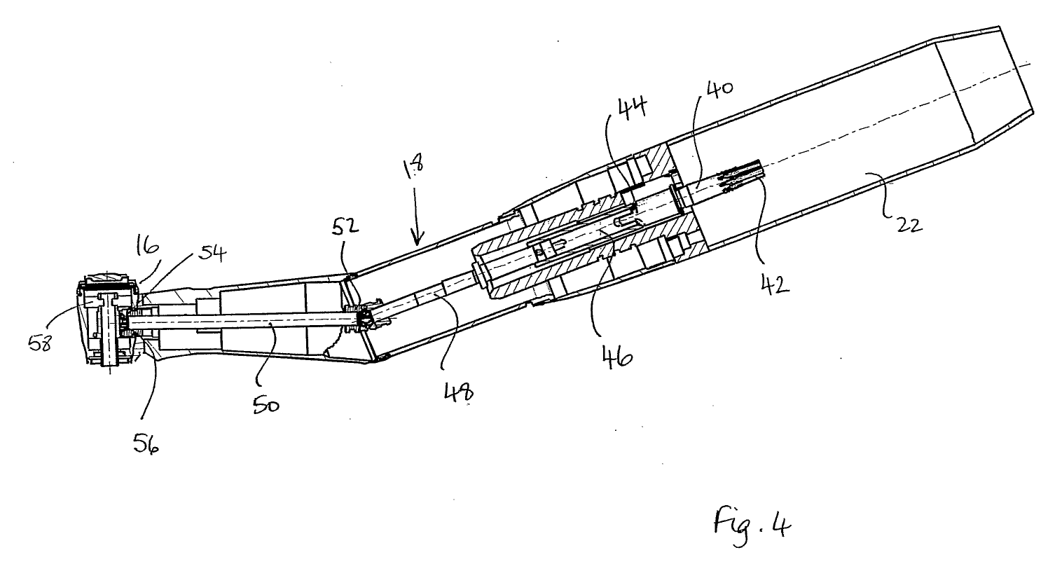

FIG. 3 shows an arrangement for driving an endodontic file 10. The file is mounted in the head 16 of a dental handpiece 18. The handpiece connects to a housing 20 and a motor 22 is contained within this housing. When the handpiece is connected to the housing 20, the motor will drive the file 10 in rotation.

The motor is controlled from a separate control unit 24. The control unit is set to drive the motor (which is preferably a stepper motor) in a forward direction and to periodically reverse the direction of rotation of the motor. The motor will only be operating in reverse (if at all) for very short periods (for example, the reverse current can be applied for 2 milliseconds) before the current reverts to forward motion, and the play in the transmission from the motor to the file will mean that the file is never actually rotating in the reverse direction. The motor never stops rotating although there will be a monetary zero rpm state if the motor rotation does reverse, when changing from forward rotation to reverse rotation. However, the forward motion of the file will decelerate and then accelerate which will induce a pulse in the file.

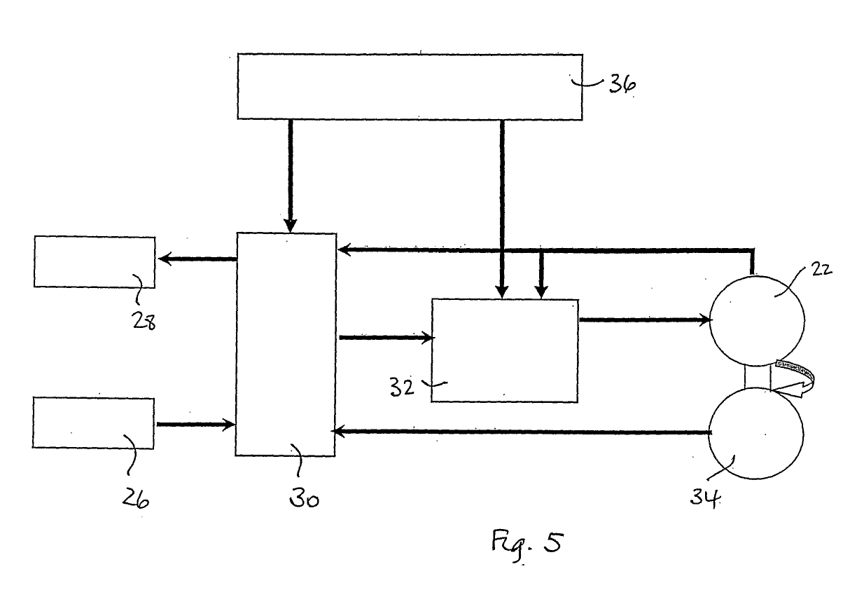

FIG. 4 shows the transmission path of a conventional drill handpiece through which the motor 22 rotates the drill head 16. The motor has an output shaft 40 which is splined at 42 to the motor rotor. The outer end of the shaft 40 has a dog 44 which is push-fit into a spring-loaded socket 46 which in turn is engaged with a first drive shaft portion 48. This drive shaft portion meets a second drive shaft portion 50 in a universal joint 52. The drive shaft portion 50 ends in a bevel gear 54 which meshes with a mating bevel gear 56 mounted for rotation about an axis at right angles to the direction of rotation of the shaft portion 50. The bevel gear 56 is fast with a driving plate 58 which engages with a non-round portion on the mandrel of a dental drill or, in this case, an endodontic file. Between each of these components of this drive train, there will be a small degree of play or backlash, and in total this will be such that the short period of reversal of the motor rotation will be such that the driving plate 58 is not itself reversed.

The pulse may be a momentary variation in the torque applied to the file mandrel. It is believed that the file will then unwind slightly whilst the torque is reduced and then wind up again when a higher torque is re-applied. Altering the amount of torsion energy stored in the file will result in a change of the physical dimensions of the flutes. It is even possible for the change in the physical dimensions of the flutes to result in part of the fluted portion of the file rotating in a reverse direction so that the back edge of a flute becomes the leading edge for a short period of time.

FIG. 5 shows details of the motor control unit 24. An operator control module 26 allows the operator to set the pulse width (i.e. the duration of motor reversal) and rate (the frequency of motor reversal) and a display 28 displays motor rpm, rotation direction, voltage and current. Current and voltage can be used as a measure of work carried out by the file for a specified depth of cutting in the canal. The module 26 feeds in to a microprocessor 30, which generates a pulse width modulated pulse train at the selected frequency. The microprocessor also measures the motor current and voltage. A power supply 36 supplies power to all the processor functions and provides the DC supply to the motor 22.

The magnitude and/or frequency of the backward pulse required is likely to be inversely proportional to the diameter of the file and is likely to be proportional to the speed at which the file is being driven. If the frequency of pulses is increased, this reduces the time allowed for the file to slow down enough to have an appreciable effect on the rate of progress of the file through the root canal. The greater the flexibility of the file, the pulse is longer.

As a result of the improved efficiency available as a result of this invention, it may be possible to use files made from different alloys or even composite materials. For example, it may be possible to use stainless steel at really low rpm.

Tests have shown excellent results when the motor is driven in reverse for very short periods. The same effect may very well be produced by applying momentary forward acceleration and deceleration pulses. This could well be beneficial with a rigid drill bit. This would also cover the possible application of a rapid backward and forward “cleaning” or “sanding” application or indeed vibrations with a specific waveform.

The frequency of the motor reversals may vary in relation to the depth of insertion of the endodontic file within the canal. Because of the tapered shape of the file, as the file enters the canal, the increasing diameter of the portion of the file in the canal may require a shorter duration or increased frequency of pulses.

It is possible to electronically monitor the rate of apical progress, and feedback from this monitoring can be used to adjust the duration and/or frequency of motor interruptions to achieve the most favorable progress.

1. Apparatus for shaping and cleaning a root canal, the apparatus Comprising:
a drill driven by an electric motor through a transmission system;
means for mounting an endodontic file in a drill head; and
means for causing the motor to rotate at a normal speed in a normal rotational direction and for intermittently causing the motor to rotate at a speed and/or direction substantially different from the normal speed or direction for a very short time.

2. Apparatus as claimed in claim 1, wherein speed substantially different from normal speed is a speed in an opposite direction of rotation.

3. Apparatus as claimed in claim 1, wherein the motor is a stepper motor.

4. Apparatus as claimed in claim 1, wherein the transmission system comprises a shaft drive and meshing gears and/or dogs.

5. Apparatus as claimed in claim 2, wherein time for which the motor is reversed is less than time needed to produce reverse rotation of the endodontic file.

6. Apparatus as claimed in claim 1, wherein intermittent changes in motor rotation preferably take place regularly.

7. Apparatus as claimed in claim 1, wherein a normal speed is in the range 300 rpm to 650 rpm.

8. Apparatus as claimed in claim 1, wherein interruption time during which the normal speed is interrupted is in the range of 1 to 4 milliseconds.

9. Apparatus as claimed in claim 1, wherein the interruption takes place at a frequency of up to 100 Hz.

10. A method of shaping and cleaning a root canal, the method comprising:
using a dental drill driven by an electric motor;
mounting an endodontic file in a drill head;
operating the motor at a normal speed in a normal rotational direction in which flutes of the file are in a cutting mode; and
driving the motor intermittently, while the file is within the root canal at a speed and/or direction substantially different from the normal speed or direction.

11. A method as claimed in claim 10, wherein speed substantially different from normal speed is a speed in an opposite direction of rotation.

12. A method as claimed in claim 11, wherein time for the motor is reversed is less than time needed to produce reverse rotation of the endodontic file.

13. A method as claimed in claim 10, wherein the intermittent changes in motor rotation preferably take place regularly.

14. A method as claimed in claim 10, wherein normal speed is in the range 300 rpm to 650 rpm.

15. A method as claimed in claim 10, wherein interruption time during which the normal speed is interrupted is in the range of 1 to 4 milliseconds.

16. A method as claimed in claim 10, wherein the interruption takes place at a frequency of up to 100 Hz.

17. A method as claimed in claim 10, wherein, engaged with a workpiece, the motor is driven in reverse for a period which is short enough not to result in any change in the direction of rotation of the bit.

18-19. (canceled)
